(19) United States
(12) Patent Application Publication
(10) Pub. No.: US 2015/0335046 A1
(43) Pub. Date: Nov. 26, 2015

(54) Methods for improving rice nutrition via manipulation of starch crystalline structure and nutrient penetration treatment

(71) Applicants: Zhaohua Peng, Starkville, MS (US); Vivian Peng, Starkville, MS (US); Wei He, Starkville, MS (US)

(72) Inventors: Zhaohua Peng, Starkville, MS (US); Vivian Peng, Starkville, MS (US); Wei He, Starkville, MS (US)

(73) Assignee: Mississippi State University, Mississippi State, MS (US)

(21) Appl. No.: 14/544,853

(22) Filed: Feb. 23, 2015

Related U.S. Application Data
(60) Provisional application No. 61/966,490, filed on Feb. 24, 2014.

(51) Int. Cl. A23L 1/182

(52) U.S. Cl. CPC A23L 1/1826; A23V 2002/00

(57) ABSTRACT

The methods of the invention provide improved rice grain nutrition by manipulation of the rice starch crystalline structure leading to easier penetration of nutrients into the rice grain and enhancement of rice grains with nutrients, thereby creating enhanced rice grain products. In addition, methods of direct delivery of nutrients into rice grains are also presented.

### CROSS-REFERENCE TO RELATED APPLICATION

This application claims priority from U.S. Provisional Patent Application Ser. No. 61/966,490 filed Feb. 24, 2014. The entirety of that provisional application is incorporated herein by reference.

### FIELD OF THE INVENTION

The present invention relates to enhancing rice grains and improving the nutrition and stability, as well as the storage ability, of the grains. More specifically, the invention provides novel methodologies for fortifying and reconstituting rice grains and enhancing nutrition and taste by manipulating the starch crystalline structure and improving the rice grains through nutrient penetration and infusion.

### BACKGROUND OF THE INVENTION

Milled rice is deficient in almost all major classes of important nutrients including protein, fat, vitamins, minerals, and fibers except carbohydrates. The poor nutrition of milled rice has caused severe malnutrition problems in countries where rice is used as the staple food, particularly among children. It would be ideal if one could fortify all the rice used for food in the world. Current world population is over 7 billion (as of Oct. 31, 2011). Rice is estimated to be the staple food for over 3 billion people. Assuming each person consumes half of one pound of rice each day in regions where rice is the staple food with little access to other foods, one person would consume approximately 180 pounds of rice each year, on average. The total amount of rice consumed globally as staple would be approximately 540 billion pounds. If one makes 0.1¢/pound by fortifying the rice, the annual income would be approximately $0.54 billion. For the next 20 years, the commercial potential and social impact of such a process is beyond estimation. In addition, one could profit even more by producing and selling rice fortification-related equipment and reagents and by targeting high-end consumers and child food.

Existing patents disclose making rice kernels or bits using rice flour, binding agents, cross-linking agents, setting agents, and moisture barrier agents, which add a large number of polymers and chemical reagents to rice flour. The products of these technologies are meant for instant food while it is also proposed to blend with rice grains for fortification. For example, U.S. Pat. No. 5,609,896 involves the use of alginate as a binding agent and cross-linking agent to achieve production of grain shaped pieces from rice flour. U.S. Pat. No. 5,252,351 (Cox, et al.) involves cohesive vegetable products and a process for manufacture in which powdered grain is mixed with a liquid binder containing alginate and formed into a dough that can be extruded. The extruded pieces are cooked in calcium containing liquid (water) to set the binder. U.S. Pat. No. 4,844,936 (Cox, et al.) discloses cohesive vegetable products and a process for manufacture. U.S. Pat. No. 4,765,996 concerns enriched rye and barley and its production and involves coating the grain with an oil or wax coating impregnated with nutrients/minerals. Finally, WO1996029889 (Cox, et al.) discloses a vitamin augmented rice composite and a method of making the composite, in which binding, setting, and cross-linking reagents are also required.

Additionally, Chinese Patent No. 200910066637 involves free-elutriation and nutrient fortified rice and nutrients formula and a liquid-fog coating method and device. Chinese Patent Publication No. CN101396096 discloses nutrition-intensified rice and a production method. However, these technologies coat the rice grains with micronutrients using large molecules such as dextrin, starch, or zein. The nutrients used and added to the rice in these Chinese technologies can be washed away even before cooking. In addition, nutrients on the surface of the grains are subjected to oxidation thus leading to storage problems. In contrast, the present invention infuses the nutrients by penetration into the rice grain itself, which allows the micronutrients to sustain multiple washings of the rice and allows enhanced rice storage for extended time periods. Moreover, the present invention adds nothing to the rice grains except key micronutrients. The Chinese technologies add other multiple components. The invention utilizes high speed and/or pressure particles to spray the rice grains so that the nutrient particles penetrate the grains, while the Chinese methods do not contemplate such methods. Finally, the Chinese methods do not involve the methods of the invention that denature the starch crystals by heating to soften the grain structure to allow the macro/micro nutrients to penetrate the grains and recovery of the grain structure through recrystallization.

Many micronutrients have a very short shelf time due to oxidation and/or temperature sensitivity. Fortifying the rough rice before dehusking and milling (for example parboiling) leads to long time storage, strong color change, frequent contamination by microorganisms, and increased arsenic concentration in milled rice due to diffusions from the aleuone layer. In contrast, the milled rice can be fortified right before going to the market, thus reducing fortificant storage time. In addition, fortifying milled rice can avoid color change, arsenic contamination, and microorganism contamination problems. Most importantly, rice is generally cooked and consumed as milled grains. Therefore, directly fortifying the milled grains is the best methodology. However, the mature milled rice grains have a very solid structure which the fortificants generally cannot penetrate. Therefore, a good method for rice fortification has not been available thus far, while wheat and corn flour fortification has been routinely used worldwide. The present invention successfully solves milled rice grain fortification problems by using both rice starch gelatinization and recrystallization properties to assist fortificant penetration and using, for example, high speed solid fine particles of micronutrients to achieve direct penetration of the nutrients into the rice grains. These methods are simple and inexpensive and can be used by any rice farm and milling factory with minimal training. None of the current technologies are similar to the present novel technologies disclosed.

The present invention also presents a method to reconstitute rice grains without adding any chemical reagents or polymers except rice grains or rice flour, fortificants, and water. The rice grains are reconstituted using starch recrystallization after the disruption of rice grain crystalline by grinding and gelatinization with heat. No current methods exist for rice fortification like the present invention and its starch gel absorption and nutrient coating and penetration processes.

### SUMMARY OF THE INVENTION

The present invention discloses rice grain nutrient fortification and reconstitution methods using rice starch gelatinization (disruption of starch crystallization and crystalline structure) and retrogradation (recrystallization) characteristics without adding any chemical reagents or polymers from other resources. It involves methods for improving rice nutrition and taste by such manipulation and by adding/infusing nutrients into the rice grain by penetration into the rice grain. It can be used to enrich rice grain with macro/micro nutrients, for example, vitamins (water-soluble and fat-soluble), minerals, proteins, amino acids, fats, oils, Omega-3 fatty acids (DHA, ALA, and EPA, for example), antioxidants, γ-oryzanol, pharmaceutical compounds, medicines, herbs, flavorings, coloring materials, or any combinations of these and other compounds. The fortified and/or reconstituted grains can be served as a food product directly and/or can be blended with unfortified grains in a pre-determined ratio to achieve desired final concentration. In addition, the methodologies of the present invention can be used to make many different types of new rice grain products and nutrition-improved foods such as fortified rice noodles, cakes, cereal flakes, bars, baby formulas, mixtures with non-fortified rice grains, and drinks, for example.

With the foregoing and other objects, features, and advantages of the present invention that will become apparent hereinafter, the nature of the invention may be more clearly understood by reference to the following detailed description of the preferred embodiments of the invention and to the appended claims.

### BRIEF DESCRIPTION OF THE DRAWINGS

These drawings accompany the detailed description of the invention and are intended to illustrate further the invention and its advantages:

FIG. 1 depicts photographic images of rice grain comparisons under a grain fortification method of the invention.

FIG. 2 depicts photographic images of rice grain comparisons under a grain reconstitution method of the invention.

FIG. 3 depicts photographic images of rice grain comparisons for rice grains coated with a reconstituted rice layer under a process of the invention.

FIG. 4 depicts photographic images of rice grain comparisons showing control, iron-fortified, and zinc-fortified rice products using methods of the present invention.

### DETAILED DESCRIPTION OF THE INVENTION

Rice is the staple food for much of the world's population. The nutritious outer layers, including the aleurone layer, subaleurone layer, germ (embryo), pericarp, tegmen, and nucellus are removed as bran during milling. Milled rice is deficient in almost all major classes of important nutrients including protein, fat, vitamins, minerals, and fibers except carbohydrates. The protein, vitamin E, and iron contents are particularly low compared with other cereal crops. Additionally, milled rice has very little zinc and little if any vitamin A. Therefore, such rice generally lacks sufficient nutrients to be life-sustaining if used as the sole source of food. The poor nutrition of milled rice has caused severe malnutrition problems in developing countries of the world where rice is served as the staple food. The malnutrition problem is more pronounced for children, older persons, and active persons. Enriched wheat and corn flour has been very successful in improving human diet worldwide. However, the challenge has been to fortify rice grain since rice is cooked and served as a whole grain food. No methods currently exist to add nutrients into a matured dry rice grain. The present invention discloses new rice grain products and methods to reconstitute fortified rice grains using only rice products and desired fortification nutrients and methods to allow injection and incorporation of micronutrients to directly penetrate the rice grains. The methods of the invention provide fortified grains that maintain the texture, taste, smell, flavor, and appearance of rice.

The present invention provides for the added nutrients to stay and remain within the starch crystalline as in normal rice seeds and remains stable for both shipping and storage. The invention also provides for an inexpensive, easily-acceptable rice product for consumers that is indistinguishable from normal rice, particularly when blended with typical, unimproved rice. Macro/micro nutrients that can be used to enhance rice grains include, but are not limited to, vitamins (water-soluble and fat-soluble), minerals, proteins, amino acids, fats, lipids, oils, Omega-3 fatty acids (DHA, ALA, EPA, for example), antioxidants, γ-oryzanol, pharmaceutical compounds, medicines, herbs, flavorings, coloring materials, natural flavor ingredients, fiber, and/or bran, or any combination thereof. The term lortificane as used herein indicates any of these, or combinations thereof, nutrients or enriching additives. Up to the typical maximum daily recommended nutritional allowances of these additives for humans can be used.

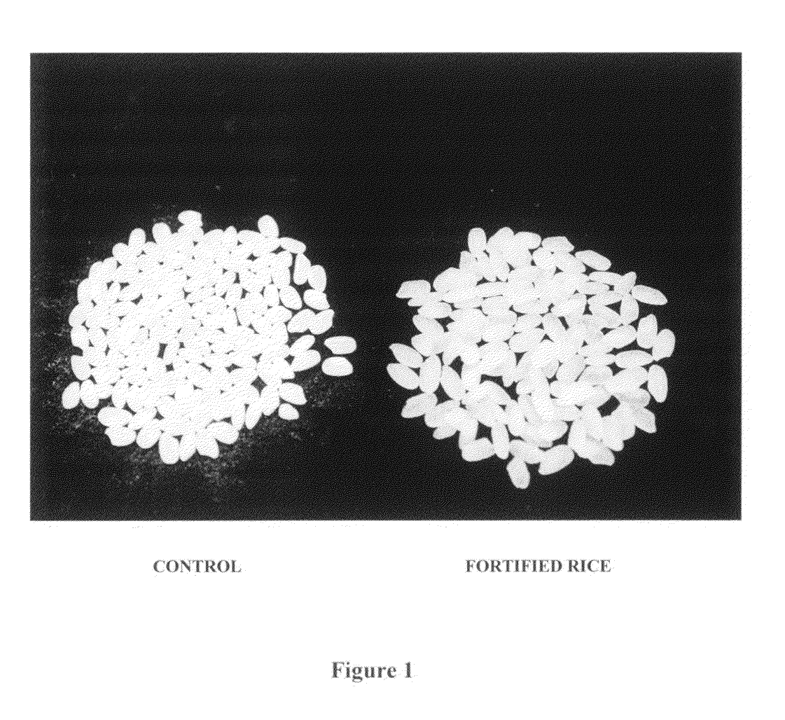

FIG. 1 shows images of rice grain comparisons under a grain fortification method of the invention. The left image is of regular milled rice grains (control). The right image is of milled rice grains treated with complex B vitamins using Process 1 of the invention. The color difference shows that the vitamins have penetrated the grain and have been retained after extensive washings as no more powders generated in milling were presented in the sample.

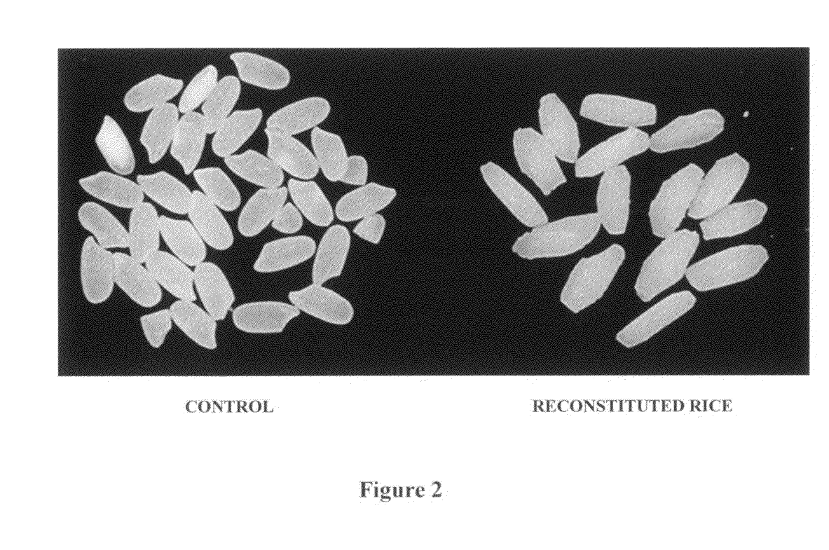

FIG. 2 shows images of rice grain comparisons under a grain reconstitution method of the invention. The left image is of regular rice grains (control). The right image is of reconstituted rice grain using Process 2 of the invention. The grain can be shaped into any form as determined by the mode. The grains shown in the right image were formed by simple hand cuts to reveal the nature of reconstitution by the method of the invention. The grains were fortified with minerals and vitamins. Only rice products and fortificants were used for the rice reconstitution.

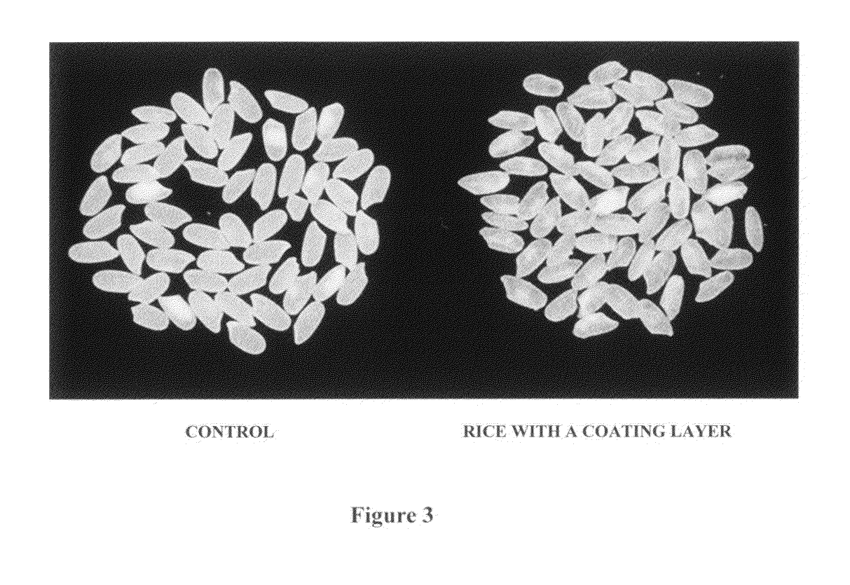

FIG. 3 shows images of rice grain comparisons for rice grains coated with a reconstituted rice layer under a process of the invention. The left image is of regular rice grains (control). The right image is of rice grains coated with a thin layer of reconstituted rice using one of the methods in Process 2, which are fortified with minerals and vitamins. Only rice products and fortificants were used for the rice reconstitution.

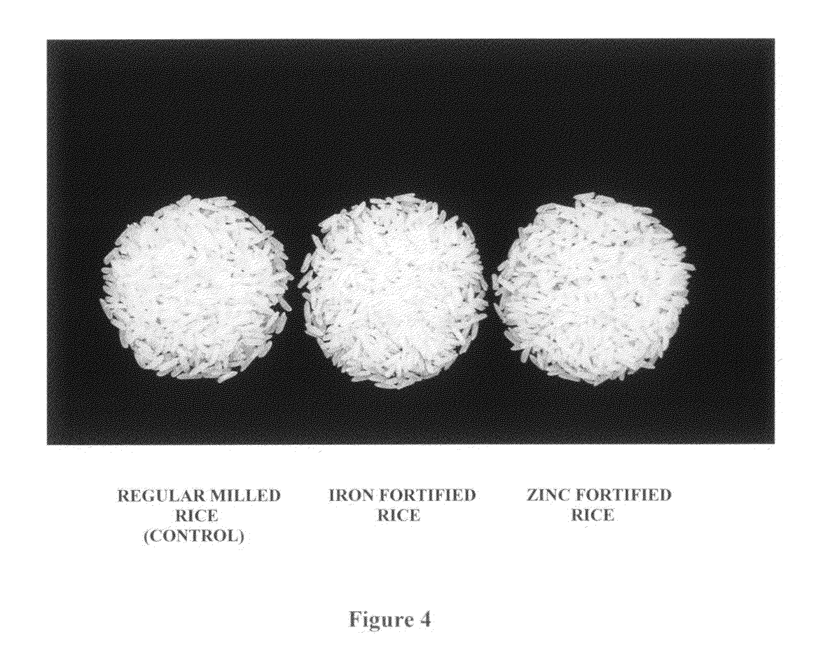

FIG. 4 shows images of rice grain comparisons showing fortified rice products of the present invention with 50% of the recommended daily allowance of nutrients. The left image is regular milled rice (control). The middle image is iron-fortified rice (NutraFine RS) produced using the methods of the invention. The right image is zinc-fortified rice (zinc sulfate) produced using the methods of the invention. The methods of Process 3 were used for the iron fortification treatment of the middle products. The methods of Process 1 were used for the zinc fortification treatment of the right side products. Multiple alternative embodiments are contemplated by the invention, the preferred embodiments being described below.

### Processes:

Process 1.
1) Soak milled rice grains in cold or warm water (below starch gelatinization temperature) supplemented with minerals, vitamins, and/or other nutrients until the grains are swollen.
2) Drain the imbibed rice grains and steam and/or microwave cook them until gelatinization occurs.
3) Sit the cooked grains in a refrigerator or alternatively room temperature for starch recrystallization with controlled moisture levels. Allow the grains to be idle at a temperature of about 4° C. or lower, or alternatively at room temperature.
4) Dry the recrystallized grains to the moisture level of normal milled rice grains.
5) Mix the fortified rice with regular rice grains in a pre-determined ratio such as about 1 to 100, for example, to achieve desired final concentration.
6) Cook as you would normal rice.
   Procedure 1: Soak the milled rice grains in water supplemented with minerals, vitamins, and/or other nutrient molecules in concentrations as designed from about several hours to overnight, depending on the water temperature. The swelling of the starch leads to absorbing (imbibing) of the minerals, vitamins, and other vitamins into the rice grains. As an option, applying vacuum can improve the infiltration process. After the grains are fully swollen, drain the grains and steam and/or microwave cook (either with or without high pressure) the grains to gelatinization. The steam time is variable, depending on the grain size. Then, transfer the steam cooked grains to a temperature-controlled and moisture-controlled environment for starch recrystallization. The recrystallized grains are dried to the moisture level of regular milled rice grains. The fortified rice grains can be mixed with regular rice grains in a pre-determined ratio and cooked as one would for normal rice.

The essential steps are to: Allow nutrients to penetrate the rice grain by imbibing (absorbing) and to allow the grains to recover the structure by temperature-induced gelatinization and then achieve recrystallization in a lower temperature.

Process 2.
1) Grind selected rice into fine rice flour, mix rice flour with about ¼ to ⅓ volume of cold water, and steam and/or microwave cook the rice flour/water mixture. Alternatively, soak and steam and/or microwave cook selected rice grains and grind the cooked rice thoroughly and knead until it attains a pizza dough consistency.
2) Introduce preferred vitamins/minerals/nutrients and mix thoroughly until the mixture has the consistency of formable extrudable rice dough, similar to pizza dough.
3) Remodel the extrudable fortified rice dough to rice grain shape, or wrap the rice dough around a small amount of other nutrient(s), such as in pill form, which is made of bran, wheat germ, protein, or other nutrients, or coat normal rice grains (unfortified) with a thin layer of the gel of the fortified rice dough.
4) Allow fortified rice grains to sit to promote recrystallization, at a temperature of about 4° C. or lower, or alternatively at room temperature.
5) Dry the rice (to the moisture level of normal rice grains).
6) Mix the fortified rice with regular or normal rice grains in a pre-determined ratio such as about 1 to 100, for example, to achieve the desired final concentration.
7) Cook as you would for normal rice.
   Procedure 2: Grind rice grains to flour, mix the flour with about ¼ to ⅓ volume of water, steam or microwave cook the wet flour for about 20 minutes (depending on the volume), mix the cooked flour thoroughly until it can be stretched as a paper like pizza dough. Alternatively, soak and steam and/or microwave cook the rice grains first and then grind the cooked grains thoroughly and knead until the mixture appears like pizza dough. Mix the dough with minerals, vitamins, and/or other desired nutrients and remodel the rice flour into the rice grain shape. Another option is to wrap the rice dough around a small amount of other nutrient(s), such as in pill form, which is made of bran, wheat germ, protein, or other desired nutrients, or coat the regular rice grains with a thin layer gel of the fortified rice dough. Allow the starch of the rice dough to recrystallization at low temperature (in refrigerator at about 4° C. or lower, or at room temperature) with time. It generally takes about one day to about one week for the recrystallization process to be completed. Then allow the enriched grains to dry and package the finished fortified grains. In addition to shaping them as grains, one can also make noodles, cakes, bars, baby formula, and many other different types of foods with the enriched flour. The fortified grains can be mixed with unfortified rice grains in a pre-determined ratio.

The essential steps are: To break the grain to fine powders to thoroughly mix with nutrients (such as vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof). Reconstitute the rice grains via a gelatinization and recrystallization cycle.

The stability of a fortificant is a very important parameter for the fortification of food that needs to be kept for a long time on shelf, such as rice grains. Unstable micronutrient fortificants may cause color and taste change of the fortified food. For example, ferrous sulfate can easily cause rancidity and affect the food color and flavor. Water dry fortificants are usually more stable and the powder form of soluble fortificants are also more stable than solubilized form. Although water insoluble micronutrient fortificants cannot be dissolved in the water, some of them can be easily solubilized in the acid environment of the digestion track. Therefore, they still have good bioavailability and have been widely used as micronutrient fortificants in baby formula and in the flour of wheat and corn. However, to use insoluble fortificants in rice grain is highly challenging because the tough structure of rice grains makes it highly challenging for the insoluble micronutrients to penetrate into the grain. So far, there is no successful report of using insoluble micronutrient fortificants in rice. Processes 3 and 4 provide solutions for insoluble nutrient fortification. These methods are also applicable for the powder form of soluble fortificants.

Process 3.
1) Denature the starch crystalline of rice grains, or only the surface layer of the rice grains by steaming. The purpose is to soften the whole rice grain or the surface layer of the rice grain.
2) Ground at least one micronutrient to fine powder and force or push the the micronutrient powder into the rice grain by methods of high speed spray and/or high speed or pressure air or inert gas or inert gas assisted spray, for example, or by rubbing them into the grain.
3) Remove the unpenetrating fortificant powders by blowing and/or by sieving.
4) Recover the starch crystalline structure of the fortified rice grain by sitting or idling them in low temperature, such as about 4° C.
5) Dry the fortified rice grain slowly and mix the fortified rice grains in a predetermined ratio with regular rice to achieve the desired final concentration.

Once the crystalline is recovered, the micronutrient fortificants are embedded into the starch crystalline and stay very stably. Retention studies indicate, for example, that the retention rate of powder element iron was over 85% after multiple washings and cooking. A good retention rate is very important because it is a tradition to wash the rice grains before cooking.

The essential steps are to: Soften the milled rice grains or the surface layer of the rice grains by soaking and/or steaming or direct steaming. Make the desired micronutrient(s) into fine powder(s). Force the fine micronutrient powders to penetrate the rice grains by a high speed spray and/or high speed or pressure air or inert gas or inert gas (nitrogen, for example) assisted spray, for example, or by a rubbing process, or a combination thereof. Recover the starch crystalline structure by temperature and moisture control. Mix the fortified rice with regular rice to achieve the desired final concentration.

Process 4.
1) Grind at least one micronutrient into fine powder.
2) Mix the micronutrient powders with at least one porous mineral powder, such as NutraFine RS iron powder, or zinc or zinc-based mineral, or other essential mineral or mineral-based element or component. The process can also consist of utilizing only at least one micronutrient powder without any porous mineral or porous mineral powder mixed in with the micronutrient powder(s).
3) Spray the micronutrient powder, or the micronutrient powder mixed with the at least one porous mineral powder, directly into the dry rice grain with very high speed spray and/or pressure, for example using at least about 2200 PSI high speed and/or pressure air spray or inert gas (nitrogen, for example) or inert gas assisted spray to spray the powders into the rice grains kept in vacuum. Vacuum is not required but the penetration process is more efficient in vacuum. Some of the powders will penetrate into the rice grain or make a deep dent on the surface. Remove the unpenetrated fortificant powders by blowing and/or sieving.
4) Mix the fortified rice grains in a predetermined ratio with regular rice grain to achieve the final desired nutrient concentration.

The essential step is to: Speed up the micronutrient powder, or micronutrient powder and porous mineral powder mixture, until it can penetrate the grain. Iron powders, for example, have a good hardness and thus they can penetrate the rice grains once being sufficiently sped up. Other nutrients will go together once mixed with iron. The micronutrient retention rate depends on the speed/pressure of spray and the strength of washing. Approximately a 30% percent of retention rate was obtained when the NutraFine RS iron powders were shot with a Bio-Rad gene gun at highest speed and washed three times, for example, in the kitchen. The simple methodologies of the invention should have high potential for micronutrient fortification on a large scale. The forcing methods of the micronutrients into the rice grains under the processes (3 and 4) of the invention includes utilizing at least one device, including an electrostatic gun or device that charges the particles and applies an electric field to speed up particle movement, that make the small micronutrient particles move quickly and quickly enough to sufficiently penetrate the rice grains. The mixing of the fortified and/or reconstituted grains with normal rice grains is optional for the processes of the invention.

### Iron and Zinc Fortificant Retention Assays in Rice

Iron and zinc fortificant retention assays were carried out by comparing the concentration of fortificants in different samples, including fortified samples and fortified samples with washing and cooking (results below). The results showed that the fortification methods of the invention had over 85% retention rate for zinc sulfate (fortified using Process 1) and NutraFine RS iron (fortified using Process 3). In contrast, the retention rate of the iron-fortified rice currently available on the market, which is the only micronutrient fortified rice available currently in the local market, was only 7.7% (see below). All mineral content analyses were completed by the Mississippi State Chemistry Laboratory for verification purposes.

### Results of Micronutrient Retention Studies

Zinc Retention Test Results

| | | Results |
|---|---|---|
| Sample | Test | (mg/Kg) |
| CONTROL: Jasmine Rice | Zinc | 16.2 |
| Zinc Sulfate fortified rice (before washing) | Zinc | 427.3 |
| Zinc Sulfate fortified rice (after three washings | Zinc | 404.4 |
| and cooking) | | |

Iron Retention Test Results

| | | Results |
|---|---|---|
| Sample | Test | (mg/Kg) |
| CONTROL: Jasmine Rice | Iron | 5.2 |
| NutraFine RS fortified rice (before washing) | Iron | 1017.3 |
| NutraFine RS fortified rice (after three washings | Iron | 869.9 |
| and cooking) | | |

Iron Retention test results of the sample bought in
Walmart

| | | Results |
|---|---|---|
| Sample | Test | (mg/Kg) |
| Iron Fortified Rice (Walmart) | Iron | 27.0 |
| Iron Fortified Rice (Walmart) (after three washings | Iron | 2.1 |
| and cooking) | | |

### Palatability Tests on Zinc and Iron Fortified Rice

The impact of nutrition fortification on the taste and appearance of the fortified food determines if a fortificant or a fortification method can be accepted by the public. Therefore, palatability tests for various fortified rice are very critical experiments in the inventors' research. A fortified rice appearance test and fortified rice taste test were performed. In the appearance test, volunteers were given several bags of rice labelled with randomly-selected four-digit numbers, in which one control rice was included. The volunteers were instructed to pick up the ones which looked different. The test results indicated that none of the volunteers could see any difference between the fortified rice and the control rice. In the taste experiment, volunteers were served with several cooked rice samples randomly labelled with a four-digit number and one control rice (termed marked control). One control rice, which was also labelled with a four-digit number, was termed hidden control. The results showed that none of the volunteers could tell the difference between fortified rice and the control rice in taste for both iron and zinc fortified rice. Both the marked control and the hidden control were included in the tests for comparison purposes (table below for taste results). Overall, the test results suggest that the fortification methods of the invention do not cause any appearance change or taste change in rice.

| | | | | | Ferric |
|---|---|---|---|---|---|
| Sensory | | NutraFine | Zinc | | sodium |
| Evaluation of | Control | RS | sulfate | Control | EDTA |
| Rice Taste after | Rice | fortified | Fortified | Rice | Fortified |
| cooking | (marked) | Rice | Rice | (hidden) | Rice |
| Extremely | 57.14% | 71.43% | 57.14% | 42.86% | 71.42% |
| Acceptable | | | | | |
| Moderately | 42.86% | 28.57% | 28.57% | 28.57% | 14.29% |
| Acceptable | | | | | |
| Acceptable | | | 14.29% | 28.57% | 14.29% |
| Moderately | | | | | |
| Unacceptable | | | | | |
| Unacceptable | | | | | |

The present invention discloses new rice grain products and novel processes and methodologies of making rice grain products that possess fortified nutrients and enhanced nutrition and taste. The invention provides methods to allow the rice grain to absorb the most nutrients at various temperatures, yet minimize or entirely avoid the possibility of fragile grains.

The above detailed description is presented to enable any person skilled in the art to make and use the invention. Specific details have been revealed to provide a comprehensive understanding of the present invention, and are used for explanation of the information provided. These specific details, however, are not required to practice the invention, as is apparent to one skilled in the art. Descriptions of specific applications, analyses, and calculations are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown and the invention is to be accorded the widest possible scope consistent with the principles and features disclosed herein.

While various embodiments of the present invention have been described above, it should be understood that they have been presented by way of example and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

The processes, methods, and systems of the present invention are often best practiced by empirically determining the appropriate values of the operating parameters, or by conducting simulations to arrive at best design for a given application. Accordingly, all suitable modifications, combinations, and equivalents should be considered as falling within the spirit and scope of the invention.

What is claimed is:

1. A method of fortifying and reconstituting rice grains, the method comprising:
soaking rice grains in water for a time sufficient to swell the grains, wherein the water comprises water having at least one enriching nutrient additive, to form fortified swollen rice grains;
draining the swollen fortified rice grains from excess water and cooking the fortified rice grains by steaming, microwaving, or a combination thereof, until gelatinization of the fortified rice grains occurs;
controlling the ambient air moisture level;
recovering the starch crystalline structure of the gelatinized swollen fortified rice grains by allowing the fortified rice grains to be idle for a sufficient time period at a temperature of about 4° C. or lower, or alternately at room temperature;
drying the recrystallized gelatinized swollen fortified rice grains to a moisture level consistent with the moisture level of unfortified rice grains; and
optionally mixing the fortified rice grains with unfortified rice grains to achieve the desired final concentration.

2. The method of claim 1, wherein the at least one enriching nutrient additive is at least one water-soluble vitamin, fat-soluble vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof.

3. A fortified rice grain product made by the method of claim 1.

4. The rice grain product of claim 3, wherein the product is in the form of fortified rice noodles, cakes, cereal flakes, bars, baby formulas, drinks, or mixtures with non-fortified rice grains, or a combination thereof.

5. A method of fortifying and reconstituting rice grains, the method comprising:
grinding rice grains into rice powder flour;
mixing the rice powder flour with about ¼ to about ⅓ volume of water, wherein the water comprises about 25% to about 33% of the total volume, to form a first mixture;
cooking the rice flour powder and water first mixture by steaming, microwaving, or a combination thereof;
mixing the cooked rice powder flour and water first mixture with at least one first enriching nutrient additive for a sufficient time period such that the first mixture forms a second mixture comprising a formable, extrudable rice dough having a dough consistency;
remodeling the rice dough second mixture into remodeled rice;
recovering the starch crystalline structure of the remodeled rice by allowing the remodeled rice to be idle for a sufficient time period at a temperature of about 4° C. or lower, or alternately at room temperature; and
drying the recrystallized remodeled rice to a moisture level consistent with the moisture level of unfortified rice grains.

6. The method of claim 5, wherein the at least one first enriching nutrient additive is at least one water-soluble vitamin, fat-soluble vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof.

7. The method of claim 5, wherein the rice dough second mixture is wrapped around at least one second enriching nutrient additive, the starch crystalline structure of the combination is recovered by allowing the combination to be idle for a sufficient time period at a temperature of about 4° C. or lower, or alternately at room temperature, and the recrystallized combination is dried to a moisture level consistent with the moisture level of unfortified rice grains.

8. The method of claim 5, wherein the rice dough second mixture is wrapped around unfortified rice grains, the starch crystalline structure of the combination is recovered by allowing the combination to be idle for a sufficient time period at a temperature of about 4° C. or lower, or alternately at room temperature, and the recrystallized combination is dried to a moisture level consistent with the moisture level of unfortified rice grains.

9. The method of claim 7, wherein the at least one second enriching nutrient additive is bran, wheat germ, vitamin, mineral, protein, amino acid, fat, lipid, oil, Omega-3 fatty acid, antioxidant, γ-oryzanol, or fiber, or a combination thereof.

10. The method of claim 9, wherein the at least one second enriching nutrient additive is in pill form.

11. A fortified rice grain product made by the method of claim 5.

12. The rice grain product of claim 11, wherein the product is in the form of fortified rice noodles, cakes, cereal flakes, bars, baby formulas, drinks, or mixtures with non-fortified rice grains, or a combination thereof.

13. A method of fortifying and reconstituting rice grains, the method comprising:
cooking the rice grains by steaming, microwaving, or a combination thereof;
grinding and mixing the cooked rice grains for a sufficient time period such that the cooked rice grains form a first mixture comprising a formable, extrudable rice dough having a dough consistency;
mixing the rice dough first mixture with at least one first enriching nutrient additive to form a rice dough second mixture;
remodeling the rice dough second mixture into remodeled rice;
recovering the starch crystalline structure of the remodeled rice by allowing the remodeled rice to be idle for a sufficient time period at a temperature of about 4° C. or lower, or alternately at room temperature; and
drying the recrystallized remodeled rice to a moisture level consistent with the moisture level of unfortified rice grains.

14. The method of claim 13, wherein the at least one first enriching nutrient additive is at least one water-soluble vitamin, fat-soluble vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof.

15. The method of claim 13, wherein the rice dough second mixture is wrapped around at least one second enriching nutrient additive, the starch crystalline structure of the combination is recovered by allowing the combination to be idle for a sufficient time period at a temperature of about 4° C. or lower, or alternately at room temperature, and the recrystallized combination is dried to a moisture level consistent with the moisture level of unfortified rice grains.

16. The method of claim 13, wherein the rice dough second mixture is wrapped around unfortified rice grains, the starch crystalline structure of the combination is recovered by allowing the combination to be idle for a sufficient time period at a temperature of about 4° C. or lower, or alternately at room temperature, and the recrystallized combination is dried to a moisture level consistent with the moisture level of unfortified rice grains.

17. The method of claim 15, wherein the at least one second enriching nutrient additive is bran, wheat germ, vitamin, mineral, protein, amino acid, fat, lipid, oil, Omega-3 fatty acid, antioxidant, γ-oryzanol, or fiber, or a combination thereof.

18. The method of claim 17, wherein the at least one second enriching nutrient additive is in pill form.

19. A fortified rice grain product made by the method of claim 13.

20. The rice grain product of claim 19, wherein the product is in the form of fortified rice noodles, cakes, cereal flakes, bars, baby formulas, drinks, or mixtures with non-fortified rice grains, or a combination thereof.

21. A method of producing fortified rice grains, the method comprising:
steaming the rice grains to denature the starch crystalline of only the surface of the rice grains and soften the surface of the rice grains;
forcing at least one powdered fortified micronutrient to penetrate into the denatured rice grains to form fortified rice grains;
reclaiming unpenetrated powdered fortified micronutrient by air blowing, sieving, or a combination thereof;
recovering the starch crystalline structure of the fortified rice grains by allowing the fortified rice grains to be idle for a sufficient time period at a temperature of about 4° C. or lower; and
drying the fortified rice grains and optionally mixing with unfortified rice grains to achieve the desired final concentration.

22. The method of claim 21, wherein the steaming of the rice grains denatures the starch crystalline of the entire rice grains and softens the entire rice grains.

23. The method of claim 21, wherein the at least one powdered fortified micronutrient is at least one water-soluble vitamin, fat-soluble vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof.

24. The method of claim 21, wherein the at least one powdered fortified micronutrient is a water-insoluble micronutrient fortificant, a water-soluble micronutrient fortificant, or a combination thereof.

25. The method of claim 21, wherein the forcing of the at least one powdered fortified micronutrient into the denatured rice grains is by high speed spray, high speed or pressure air, high speed or pressure inert gas, inert gas assisted spray, rubbing, or at least one device that facilitates powdered micronutrient penetration into the rice grains, or a combination thereof, and wherein the fortified micronutrient sufficiently penetrates the denatured rice grains and remains imbedded therein.

26. A fortified rice grain product made by the method of claim 21.

27. The rice grain product of claim 26, wherein the product is in the form of fortified rice noodles, cakes, cereal flakes, bars, baby formulas, drinks, or mixtures with non-fortified rice grains, or a combination thereof.

28. A method of producing fortified rice grains, the method comprising:
mixing at least one powdered micronutrient with at least one porous mineral powder to form a fortified micronutrient mixture or, alternatively, grinding and mixing at least one powdered micronutrient only to form said fortified micronutrient mixture;
forcing the fortified micronutrient mixture to penetrate into unfortified rice grains to form fortified rice grains;
reclaiming unpenetrated fortified micronutrient mixture by air blowing, sieving, or a combination thereof; and
mixing the fortified rice grains with unfortified rice grains to achieve the desired nutrient concentration.

29. The method of claim 28, wherein the forcing of the fortified micronutrient mixture into the rice grains is by high speed spray, high speed or pressure air, high speed or pressure inert gas, inert gas assisted spray, rubbing, or at least one device that facilitates powdered micronutrient penetration into the rice grains, or a combination thereof, and wherein the fortified micronutrient mixture penetrates the rice grains and remains imbedded therein.

30. The method of claim 29, wherein the high pressure air, high pressure inert gas, or a combination thereof, is about 2200 psi or higher and high enough to force the micronutrient mixture particles to penetrate the rice grains.

31. The method of claim 28, wherein the at least one powdered micronutrient is at least one water-soluble vitamin, fat-soluble vitamin, mineral, protein, amino acid, fat, lipid, oil, Omega-3 fatty acid, antioxidant, γ-oryzanol, pharmaceutical compound, medicine, herb, flavoring, coloring material, natural flavor ingredient, fiber, or bran, or a combination thereof.

32. The method of claim 28, wherein the at least one powdered micronutrient is a water-insoluble micronutrient fortificant, a water-soluble micronutrient fortificant, or a combination thereof.

33. The method of claim 28, wherein the at least one porous mineral powder is iron, zinc, or other essential mineral element, a combination thereof.

34. The method of claim 28, wherein the unfortified rice grains and the forcing of the fortified nutrient mixture into the unfortified rice grains is in a vacuum.

35. A fortified rice grain product made by the method of claim 28.

36. The rice grain product of claim 35, wherein the product is in the form of fortified rice noodles, cakes, cereal flakes, bars, baby formulas, drinks, or mixtures with non-fortified rice grains, or a combination thereof.
